(19) United States
(12) Patent Application Publication
(10) Pub. No.: US 2017/0206384 A1
(43) Pub. Date: Jul. 20, 2017

(54) DETECTION DEVICE

(71) Applicant: Siemens Aktiengesellschaft, München (DE)

(72) Inventor: Thorsten Krüger, Warngau (DE)

(21) Appl. No.: 15/326,275

(22) PCT Filed: May 11, 2015
(86) PCT No.: PCT/EP2015/060324

§ 371 Date: Jan. 13, 2017

(30) Foreign Application Priority Data
Aug. 6, 2014 (DE) 10 2014 215 591.6

(51) Int. Cl. G06K 7/10; A42B 3/04

(52) U.S. Cl. CPC G06K 7/10297; A42B 3/042; A42B 3/0433

(57) ABSTRACT

The invention relates to a detection device comprising a portable recording unit (CAM) for detecting a surrounding operating area by means of a sensor, a contactless communication interface (IF) for receiving identification data, and an analyzing unit (CTR) for analyzing the identification data and for activating the recording unit (CAM) dependent on the analysis. The advantage of the invention and the embodiments of the invention over conventional recording systems is characterized, among others, in that only work steps in a definable surrounding operating area are recorded and optionally only at specific times and/or periods of times without assistance from an operator. As an expandable system, not just audio and video streams can be recorded and analyzed but also additional surroundings data, such as temperature, humidity, etc., which can be used with respect to the audio and video data.

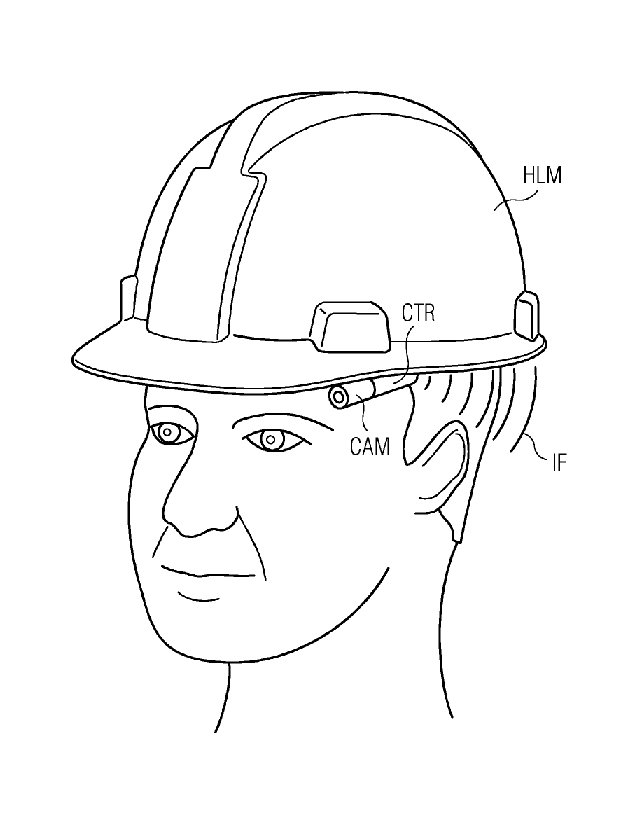

### CROSS-REFERENCE TO RELATED APPLICATIONS

This application claims priority to PCT Application No. PCT/EP2015/060324, having a filing date of May 11, 2015, based off of German application No. DE 102014215591.6, having a filing date of Aug. 6, 2014, the entire contents of which are hereby incorporated by reference.

### FIELD OF TECHNOLOGY

The following relates to a detection device for detecting an operating environment.

### BACKGROUND

Many work processes in the industrial, operational or medical environment require documentation of individual working steps. These working steps include, for example, taking into operation and maintaining machines or also medical examinations by a doctor.

At present, corresponding working steps are predominantly documented in writing, such documentation usually being performed after the conclusion of the working steps, from memory. The consequence is that working steps are mostly documented incompletely or faultily.

A documentation of working steps is possible by a permanent detection by means of a video recording device which is connected to a body part of a person performing the working steps. For example, use of helmet cameras for recording working steps is known. By means of a mechanical coupling located inside the helmet camera with the head of the person, helmet cameras automatically detect the field of view of the person so that no further means or helping persons are required for detecting the operating environment. This type of documentation, however, has the disadvantage that an operating person must determine himself when the operating field is reached in order to start a video recording of the working steps and correspondingly ending it when leaving the operating field.

From the known art, event-controlled detection devices are known in the case of a fault-triggering event. Printed document DE69615713T2 discloses a stationary detection device for directing quality, fault finding and security purposes. In this context, a video recording of an operating environment in the temporal environment of a fault-triggering event is provided. Events to be mentioned are, for example, inadequate pressure in a production environment or incorrect positioning of production parts. In order to ensure that subsequent evaluation of the operating environment is possible not only after occurrence of such an event, a continuous video recording of the operating environment is proposed which is stored in a cyclically overwritable storage device. On occurrence of an event, archiving of a part-area of the video recording occurs in a manner that the part-area to be archived extends over a period which begins before a definable period of the occurrence of the event and ends after a definable period after the occurrence of the event. This measure provides for a subsequent evaluation of cause and effect of an event.

The teaching disclosed has a number of disadvantages for a detection of an operating environment, particularly for the documentation of individual working steps. On the one hand, the detection device disclosed is tied in a stationary manner to a system to be monitored so that the latter appears to be unsuitable with its frequent changing of an operating environment of an operating person. On the other hand, a video recording is started with the occurrence of a fault-triggering event but not with beginning of working steps by an operating person by reaching an operating environment. It is not possible to link the beginning and ending of working steps with a respective event.

### SUMMARY

An aspect relates to creating a detection device portable on the body of an operating person, by which a sensor detection of an operating environment is started automatically when the operating person enters the operating environment, without a corresponding starting command by the operating person being required.

The detection device according to embodiments of the invention comprises a portable recording unit for sensor detection of an operating environment, a contactless communication interface for receiving an identification data item and an evaluating unit for evaluating the identification data item and for activating the recording unit in dependence on the evaluation.

According to embodiments of the invention, the portable recording unit is activated via a contactless communication interface. In this context, a contactless identification data item obtained, for example, via an air interface, is evaluated in the detection device according to embodiments of the invention. In this evaluation, it is checked, for example, whether the received identification data item corresponds to a predetermined value. If this is so, the sensor detection is activated.

The identification data item is received by a transmitter or identification data item generator which, for example, is arranged in the local vicinity of the operating environment to be detected.

The detection device according to embodiments of the invention advantageously enables detection with hands remaining free, in other words manual activation of the sensor detection is not necessary.

Embodiments of the invention also comprises a detection system for supporting a sensor detection of an operating environment, comprising at least one transponder with an assigned identification data item which is transmitted at least from time to time, and at least one detection device.

According to embodiments of the invention, the object is achieved by a method for detecting an operating environment by means of a portable detection device, comprising the steps: wireless reception of an identification data item; evaluating the identification data item and activating a recording unit allocated to the detection device in dependence on the evaluation and sensor detection of the operating environment.

According to one embodiment of the invention, it is provided that the contactless communication interface has a range which presupposes a local vicinity of the detection device to a transmitter of the identification data item for receiving the identification data item. An advantageous use of short- or medium-range transmitters for the transmission of the identification data item ensures simple implementation of a determination when the operating person wearing the detection device enters the operating environment, namely when the detection device of the operating person enters into radio range so that the sensor detection can be started with activation of the recording unit. For this purpose, the contactless communication interface is, for example, designed as radio interface, particularly as RFID, NFC, WiFi or Bluetooth interface, or also as optical communication interface.

Alternatively, ranges of the transmitter or of the contactless communication interface, respectively, having a greater radio range are also selectable which do not necessarily presuppose a local vicinity of the detection device to one or more transmitters of the identification data item for receiving the identification data item. In the last-mentioned alternative case, for example, means of triangulation between a number of transmitters and/or the detection device are to be set up in order to determine when the operating person carrying the detection device enters the operating environment.

According to further embodiments of the invention, it is provided that the recording unit detects the operating environment at least visually and/or audio-visually. Alternatively or additionally, any arbitrary sensor detection can be realized, particularly a detection of a temperature, of an air pressure, of an air humidity and/or of a radio activity of the operating environment.

According to one embodiment of the invention, it is provided that the detection device is equipped with an expanding interface for data exchange with sensor units external to the detection device. This advantageous measure allows an inclusion of further sensor data for detecting the operating environment.

For the rest, embodiments of the detection device also allow further modularization, for example, the evaluating unit can be part of a more extensive control and/or storage unit which is provided or carried out on a portable unit such as, e.g., a Smartphone.

According to one embodiment of the invention, a motion sensor is provided for activating the detection device. Advantageously, a portable detection device is activated in the case of a movement, for example placement against the body. The activation provided is, for example, ending a rest state or a power saving mode. This advantageous embodiment allows further avoidance of input elements for controlling the detection device. After activation of the detection device, it is ready for receiving an identification data item. Advantageously, optical and/or acoustic signaling occurs on activation of the detection device in order to inform the operating persons or persons in the environment of the operating person about the activation.

According to one embodiment of the invention, optical and/or acoustic signaling from an analogous motivation as explained above is also provided on activation of the recording unit.

### BRIEF DESCRIPTION

Some of the embodiments will be described in detail, with reference to the following FIGURE, wherein like designations denote like members, wherein:

The FIGURE shows a detection device mounted on a helmet of an operating person, consisting of or comprising a portable recording unit CAM for sensor detection of an operating environment, a contactless communication interface IF and an evaluating unit CTR for activating the recording unit in dependence on an identification data item which can be received via the contactless communication interface IF.

### DETAILED DESCRIPTION

The contactless communication interface IF is not visible in the representation of the drawing so that only the wireless effect of this contactless communication interface IF is symbolized.

The positioning at a helmet normally used in an industrial environment for the protection of personnel represented in the drawing only corresponds to an exemplary representation of a possible position. Depending on the operating environment, the detection device can also be mounted on glasses—e.g. protective glasses, optical glasses or technical glasses with camera and transparent display or also be an integral component of these. Possible locations incidentally comprise all body positions which are possible and normally used for portable computer systems in the sense of a “wearable computer”.

Incidentally, embodiments of the detection device also allow further modularization, for example, the evaluating unit can be part of a control and/or storage unit which is provided or carried out on a further portable unit such as e.g., a Smartphone.

The advantage of the embodiments of the invention, compared with conventional recording systems, is apparent, among other things, in that, without additional action of an operating person, only working steps in a definable operating environment and possibly only at particular times and/or periods are recorded. As expandable system, it is possible to record and evaluate not only audio and video streams but also further environmental data such as temperature, air humidity etc. which can be related to the audio and video data.

Coupling the detection device with Smart tags as transmitter of the identification data item allows flexible configuration of the system so that in a production line, for example, different working steps are recorded for different users.

Possible scenarios of utilization also comprise use in training. In this context, critical working steps, for example during a process of commissioning, are recorded. Video recordings can be used later, e.g. for training purposes. Furthermore, a use for quality assurance is possible. The detected data or recordings allow subsequent checking of work sequences.

In a method for detecting the operating environment by means of the portable detection device, wireless reception of an identification data item initially occurs. This identification data item is transmitted by a transponder, not shown.

As soon as the operating person passes within the radio range of a transponder also called “Smart Tag”, the detection device communicates via the communication interface IF with the Smart Tag which conveys to the detection device, for example the evaluating unit CTR of the detection device, an identification data item, preferably unambiguous within an operating location, for example a number, a MAC address, a machine-readable name or an arbitrary machine-readable data item. Alternatively, the communication between the Smart Tag and the communication interface IF can also run unilaterally so that the Smart Tag only transmits and the communication interface IF only receives. Smart Tags can be mounted, for example, at a production location, a plant gate etc.

Subsequently, evaluating of the identification data item takes place. In the evaluating unit CTR, an amount of identification data can be stored for which an activation is provided by a corresponding identification data item, conveyed by a Smart Tag, in the case of correspondence. If the identification data item conveyed from a Smart Tag corresponds with an identification data item defined in the evaluating unit CTR, activation of the recording unit CAM occurs and the sensor detection of the operating environment. Further evaluations going beyond a mere comparison of provided and received identification data allow a recording only at particular operating persons, at particular times etc.

If the operating person leaves the transmitting area of the Smart Tag, the recording unit is deactivated after a configurable period of time and the sensor detection of the recording unit is subsequently stopped.

Optionally, the detection unit can be expanded with further sensors and configured correspondingly so that, e.g. temperature values, air humidity, radio activity, etc. are also recorded.

Storage of the data provided with the sensor detection takes place either locally at the detection device or decentralized at a server. For this purpose, data streams are transmitted preferably via the contactless communication interface to a central storage unit.

To summarize, the detection device according to embodiments of the invention comprise a portable recording unit CAM for sensor detection of an operating environment, a contactless communication interface IF for receiving an identification data item and an evaluating unit CTR for evaluating the identification data item and for activating the recording unit CAM in dependence on the evaluation. The advantage of the invention and its embodiments compared with conventional recording systems is apparent, among other things, in that, without additional action of an operating person, only working steps in a definable operating environment and possibly only at particular times and/or periods are recorded. As expandable system, it is possible to record and evaluate not only audio and video streams but also further environmental data such as temperature, air humidity etc. which can be related to the audio and video data.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A detection device comprising
a portable recording unit (CAM) for sensor detection of an operating environment,
a contactless communication interface (IF) for receiving an identification data item; and
an evaluating unit (CTR) for evaluating the identification data item and for activating the recording unit in dependence on the evaluation.

2. The detection device according to patent claim 1, characterized in that the contactless communication interface has a range which presupposes a local vicinity of the detection device to a transmitter of the identification data item for receiving the identification data item.

3. The detection device according to one of the aforementioned patent claims, characterized in that the contactless communication interface is designed as radio interface, particularly as RFID, NFC, WiFi or Bluetooth interface, or as optical communication interface.

4. The detection device according to one of the aforementioned patent claims, characterized by a recording unit which comprises at least a visual and/or audio-visual detection of the operating environment.

5. The detection device according to one of the aforementioned patent claims, characterized by a recording unit which comprises at least a detection of a temperature, of an air pressure, of an air humidity and/or of a radio activity of the operating environment.

6. The detection device according to one of the aforementioned patent claims, characterized by an expanding interface for data exchange with sensor units external to the detection device.

7. The detection device according to one of the aforementioned patent claims, characterized by a motion sensor for activating the detection device.

8. The detection device according to patent claim 7, characterized by an optical and/or acoustic signaling on activation of the detection device.

9. A detection system for supporting a sensor detection of an operating environment, comprising
at least one transponder for transmitting an identification data item assigned to the transponder;
at least one detection device according to one of the aforementioned patent claims.

10. A method for detecting an operating environment by means of a portable detection device, comprising the steps:
wireless reception of an identification data item;
evaluating the identification data item; and
activating a recording unit allocated to the detection device in dependence on the evaluation and sensor detection of the operating environment.
